(19) United States
(12) Patent Application Publication
(10) Pub. No.: US 2022/0396213 A1
(43) Pub. Date: Dec. 15, 2022

(54) COUPLING ARRANGEMENT

(71) Applicant: MAXTRAX AUSTRALIA PTY LTD, Brendale (AU)

(72) Inventors: Bradley John McCarthy, Coolum Beach (AU); Neil Davidson, Wooloowin (AU); Paul Toohey, Stafford (AU)

(73) Assignee: MAXTRAX AUSTRALIA PTY LTD, Brendale (AU)

(21) Appl. No.: 17/837,919

(22) Filed: Jun. 10, 2022

(30) Foreign Application Priority Data
Jun. 11, 2021 (AU) 2021103310

(51) Int. Cl. B60R 9/048

(52) U.S. Cl. CPC B60R 9/0485

(57) ABSTRACT

The present invention relates to a coupling arrangement for coupling a vehicle recovery ladder to a vehicle. The arrangement includes a bracket for fastening to a roof rack borne by the vehicle. The arrangement further includes one or more ladder fasteners for fastening the ladder to the bracket. The fasteners extend from the bracket and through the ladder. Advantageously, the recovery ladder may be mounted to an external roof rack to avoid dirtying the interior of the vehicle.

### CROSS-REFERENCE TO RELATED APPLICATION

This application claims priority, under 35 U.S.C. Section 119, from Australian Application No. 2021103310, file Jun. 11, 2021, the disclosure of which is incorporated herein by reference in its entirety.

### FEDERALLY SPONSORED RESEARCH OR DEVELOPMENT

Not Applicable.

### TECHNICAL FIELD

The present invention relates to a coupling arrangement for coupling a vehicle recovery ladder.

### BACKGROUND

The reference to any prior art in this specification is not, and should not be taken as an acknowledgement or any form of suggestion that the prior art forms part of the common general knowledge.

Four-wheel drive (4 WD) vehicles invariably become stuck in sand and mud. Traditionally, shovels were used to dig and extricate stuck 4 WD vehicles. Alternatively, timber could be jammed beneath tyres in an attempt to gain more wheel traction.

A known vehicle recovery ladder disclosed in AU 2019240591 provides improved traction when extricating vehicles. Advantageously, the ladder is lightweight being molded from polymeric material and includes traction members to assist the wheel in climbing out of the mire.

The recovery ladder is highly effective, although becomes dirty in use making it undesirable to store in the 4 WD.

The Applicant has perceived the need for an improved means for transporting dirty recovery ladders.

### SUMMARY OF THE INVENTION

According to one aspect of the present invention, there is provided a coupling arrangement for coupling a vehicle recovery ladder to a vehicle, the arrangement including:

a bracket for fastening to a roof rack borne by the vehicle; and

one or more ladder fasteners for fastening the ladder to the bracket, the fasteners extending from the bracket and through the ladder.

Advantageously, the recovery ladder may be mounted to an external roof rack to avoid dirtying the interior of the vehicle.

The bracket may be planar. The bracket may be fastened to the roof rack using one or more bracket fasteners. The bracket fasteners may be threaded. The roof rack and/or bracket may define one or more fastening slots. The slots may receive the bracket fasteners which can then be slid along the slots to position the bracket before fastening. The bracket may include fastening holes.

The bracket may be tapered, and a ramp of the ladder may be superposed over the bracket.

The ladder fasteners may be releasably fastened to the bracket. Each ladder fastener may include a base, and a head for pivoting relative to the base. The head may be inserted through the ladder and pivoted to fasten the ladder to the bracket. The head may be of a keyhole shape and inserted through an aperture of the ladder.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in anyway. The Detailed Description will make reference to a number of drawings as follows:

FIG. 1a is a plan view of a known vehicle recovery ladder;

FIG. 1b is a side sectional view of the vehicle ladder of FIG. 1a;

FIG. 1c is a side view of the vehicle ladder of FIG. 1a;

FIG. 2 is an upper perspective view of a coupling arrangement for coupling the vehicle recovery ladder of FIG. 1 to a vehicle in accordance with an embodiment of the present invention;

FIG. 3 is an upper perspective view of a pair of coupling arrangements of FIG. 2; and

FIG. 4 shows a platform roof rack.

### DETAILED DESCRIPTION OF PREFERRED EMBODIMENTS

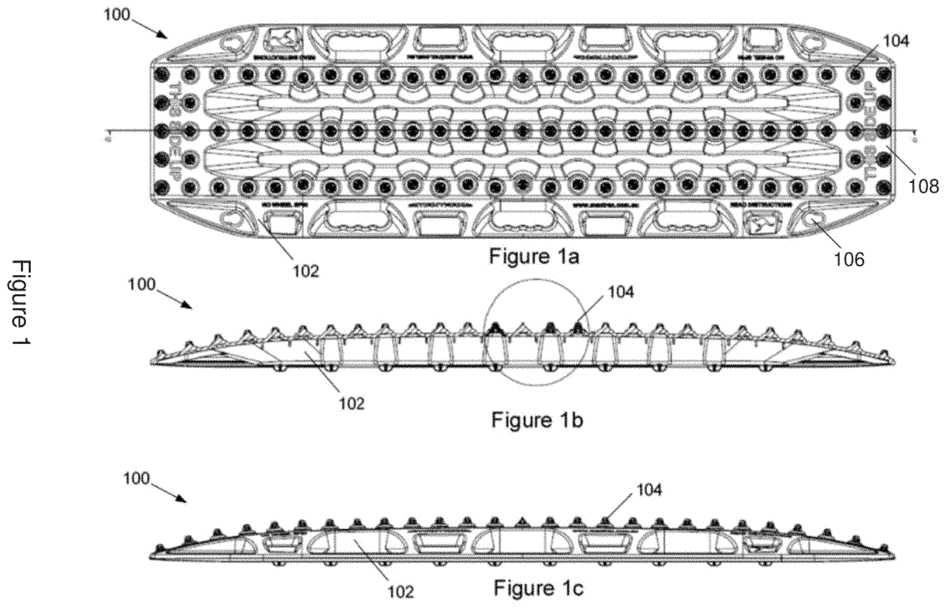

A known vehicle recovery ladder 100 is shown in FIG. 1. The ladder includes an elongate molded body 102, and molded traction members 104 that are releasably fastened to the body 104. The traction members 104 are bonded to the body 102 with a chemical and mechanical bond formed during molding. Advantageously, any damaged traction members 104 can be readily released and replaced to maintain the performance of the ladder 100.

The traction members 104 are normally less durable than a vehicle tyre so as to sustain damage before the comparatively more expensive tyre. The traction members 104 are formed from polymeric material (e.g. elastomer, polyurethane, thermoplastic, nylon). The body 102 is also formed from polymeric material (e.g. elastomer, polyurethane, thermoplastic, nylon). Typically, the body 102 and the traction members 104 are each intergrally formed (e.g. injection molded) from the same material.

As best shown in FIG. 1a, four keyhole shaped apertures 106 are located adjacent end ramps 108 of the ladder 100.

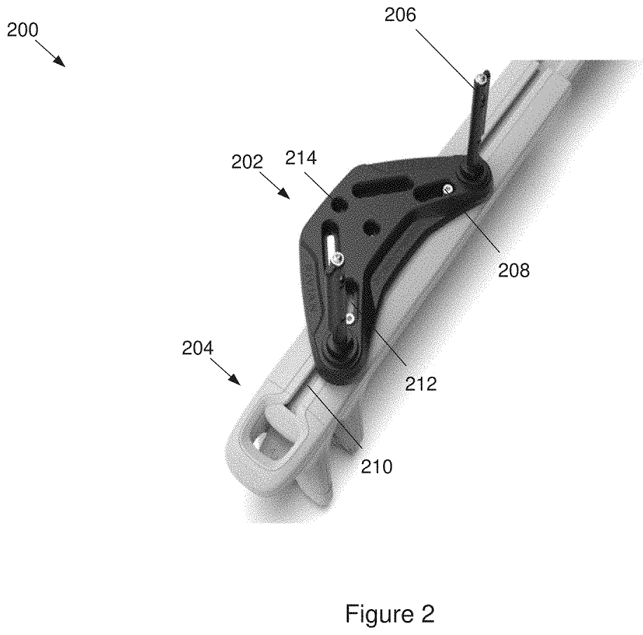

According to an embodiment of the present invention, there is provided a coupling arrangement 200 shown in FIG. 2, for coupling the vehicle recovery ladder 100 to a 4 WD vehicle. The arrangement 200 includes a planar bracket 202 for fastening to a bar roof rack 204 borne by the vehicle.

The arrangement 200 also includes upright ladder fasteners 206 for fastening the ladder 100 to the bracket 202. The fasteners 206 extend up from the bracket 202 and through the apertures 106 of the ladder 100.

Advantageously, the recovery ladder 100 can be mounted to the external roof rack 204 to avoid dirtying the interior of the vehicle.

The bracket 202 is fastened to the roof rack 204 using two threaded bracket fasteners 208, with an exposed countersunk head and enlarged tail within a slot 210 of the roof rack 204. Turning the head makes the confined tail pass along the fastener thread.

The bracket 202 also defines slots 212 for receiving the bracket fasteners 208. The slots 212 are arranged in oblique pairs to provide for universal adjustment, with the best pair selected to suit the particular roof rack configuration and/or vehicle to be used.

The slots 210, 212 receive the loose bracket fasteners 208, which can then be slid along the slots 210, 212 to position the bracket 202, before fastening (or tightening) the fasteners 208 and therefore the bracket 202 in place.

A pair of holes 214 is provided for alternatively receiving the bracket fasteners 208 and mounting the bracket 202 at 90° to the orientation shown in FIG. 2.

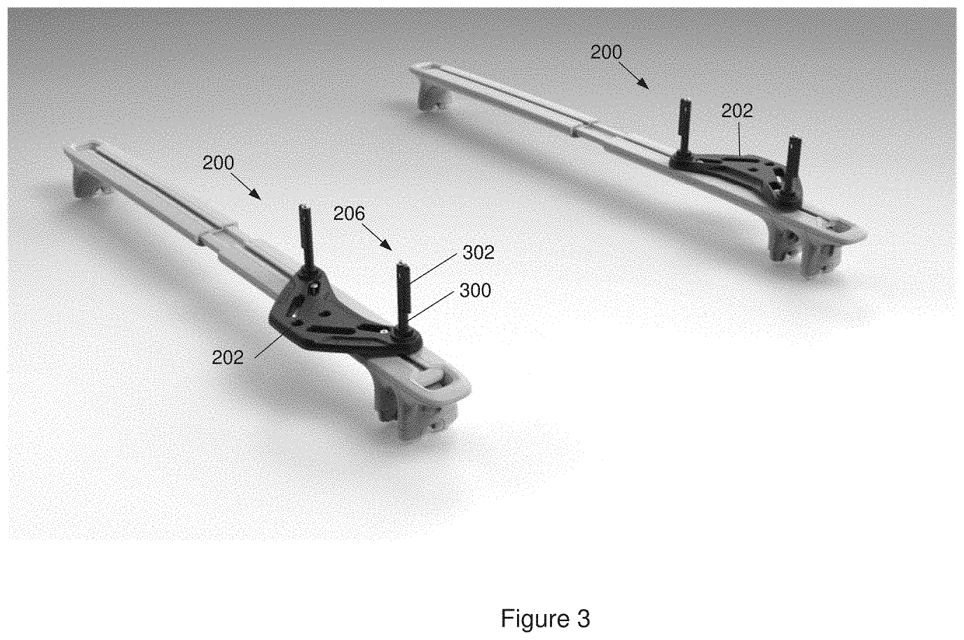

Turning to FIG. 3, a pair of spaced apart coupling arrangements 200 are used to couple the vehicle recovery ladder 100 to the 4 WD vehicle.

Each bracket 202 tapers to an apex, with the brackets 202 pointing in opposite directions. The end ramps 108 of the ladder 100 are superposed over the bracket 202 beneath.

Each ladder fastener 206 includes a base 300 fixed to the bracket 202, and a keyhole-shaped head 302 for pivoting relative to the base 300. The head 302 is inserted through an aperture 106 of the ladder 100 and then pivoted outward to fasten the ladder 100 to the bracket 202.

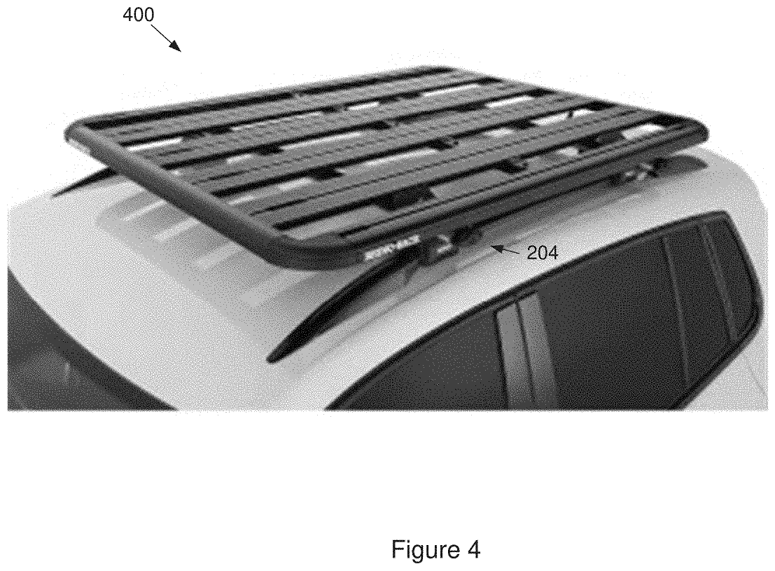

Turning to FIG. 4, the bracket 202 and ladder fasteners 206 can be fastened to a platform roof rack 400, in turn, mounted to the bar roof racks 204.

In use with reference to FIG. 2, the loose bracket fasteners 208 pass through the bracket 202, and their tails are serially slid into the end of the slot 210 of the roof rack 204.

Once the bracket 202 is correctly positioned on the roof rack 204, the bracket fasteners 208 are tightened so that the bracket 202 is fastened in place on the roof rack 204.

The ladder 100 is then placed over the ladder fasteners 206 and rests on the bracket 202 in line with the base 300 (FIG. 3). The head 302 of each ladder fastener 206 is pivoted relative to the base 300 to securely lock the ladder 100 to the bracket 202 so that it cannot lift over the ladder fasteners 206.

The ladder 100 and then bracket 202 can be removed by following the reverse steps.

A person skilled in the art will appreciate that many embodiments and variations can be made without departing from the ambit of the present invention.

In one embodiment, the ladder fasteners 206 are releasably fastened to the bracket 202.

The bracket 202 is designed to fit most platform racks 400 and crossbars 204. Up to 200 mm of adjustment is provided to suit fixed crossbars 204 of varying spacing. The bracket 200 is also suitable for mesh floor-type racks using an optional U-bolt kit. The bracket 202 can be secured to metal panels on 4 WD vehicles, camper-trailers and caravans.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1-5. (canceled)

6. A coupling arrangement for coupling a vehicle recovery ladder to a vehicle, the arrangement including:
a bracket configured for fastening to a roof rack borne by the vehicle; and
one or more ladder fasteners configured for fastening the ladder to the bracket, each of the ladder fasteners extending from the bracket so as to pass through the ladder when the ladder is placed on the bracket.

7. The coupling arrangement of claim 6, wherein at least one of the roof rack and the bracket includes at least one fastening slot, and wherein the bracket is fastened to the roof rack using a bracket fastener received in the at least one fastening slot.

8. The coupling arrangement of claim 7, wherein the bracket fastener is slidably received in the at least one fastening slot, allowing the bracket to be positioned in the at least one fastening slot before the bracket is fastened to the roof rack.

9. The coupling arrangement of claim 6, wherein the bracket is planar.

10. The coupling arrangement of claim 9, wherein the bracket is tapered to form an apex.

11. The coupling arrangement of claim 7, wherein the bracket has more than one pair of oblique fastening slots.

12. The coupling arrangement of claim 6, wherein the bracket has a pair of fastening holes.

13. The coupling arrangement of claim 6, wherein the bracket is configured to be located beneath the ladder.

14. The coupling arrangement of claim 6, wherein each ladder fastener includes a base and a head pivotable relative to the base, the head being configured for insertion through the ladder so as to be pivoted to fasten the ladder to the bracket.

15. The coupling arrangement of claim 6, wherein the recovery ladder is configured to be mountable to an external roof rack.

16. The coupling arrangement as claimed in claim 6, wherein the bracket is fastened to the roof rack with one or more bracket fasteners.

17. The coupling arrangement of claim 16, wherein each of the one or more bracket fasteners is threaded.

18. The coupling arrangement of claim 6, wherein the bracket is tapered, and a ramp of the ladder is superposed over the bracket.

19. The coupling arrangement of claim 6, wherein the ladder fasteners are releasably fastened to the bracket.

20. The coupling arrangement of claim 14, wherein the head is of a keyhole shape and is configured to be inserted through an aperture in the ladder.

21. The coupling arrangement of claim 6, wherein the bracket is fitted to a platform rack.

22. The coupling arrangement of claim 6, wherein the bracket is fitted to crossbars.

23. The coupling arrangement of claim 22, wherein the bracket is adjustable to suit fixed crossbars of varying spacing.

24. The coupling arrangement of claim 6, wherein the bracket is configured to be fitted to a mesh floor-type rack using a U-bolt kit.

25. The coupling arrangement of claim 6, wherein the bracket is configured to be secured to a metal panel on the vehicle.
